(19) United States
(12) Patent Application Publication
(10) Pub. No.: US 2023/0289821 A1
(43) Pub. Date: Sep. 14, 2023

(54) AI Chatbot Application for Crafting Appeals for Amazon, Walmart, and eBay Seller Account Suspensions

(71) Applicant: Kenneth Eade, Monaco (MC)

(72) Inventor: Kenneth Eade, Monaco (MC)

(21) Appl. No.: 18/311,262

(22) Filed: May 3, 2023

(51) Int. Cl. G06Q 30/018; H04L 51/02

(52) U.S. Cl. CPC G06Q 30/018; H04L 51/02

(57) ABSTRACT

The present invention relates to an artificial intelligence (AI) chatbot application designed to assist sellers on Amazon, Walmart, and eBay in crafting well-structured and persuasive appeals for account suspensions. The AI chatbot analyzes the specific reasons for each seller's account suspension and provides tailored recommendations for addressing the underlying issues. The system offers comprehensive support by engaging in natural language conversations with the seller, enabling them to understand the nuances of their suspension, and guiding them through the appeals process. By leveraging advanced natural language processing and machine learning techniques, the AI chatbot adapts to the unique circumstances of each seller's suspension and generates context-specific appeal letters, maximizing the likelihood of a successful reinstatement. Furthermore, the AI chatbot is capable of continuous learning, improving its appeal writing abilities, and adapting to changes in platform policies and guidelines. This invention offers a cost-effective and efficient solution for sellers seeking to regain their account privileges on Amazon, Walmart, and eBay marketplaces.

Kenneth Eade, Inventor, has invented a new AI Chatbot Application for Crafting Appeals for Amazon, Walmart, and eBay Seller Account Suspensions, as set forth in the following specification.

### FIELD OF THE INVENTION

The present invention relates to the field of artificial intelligence (AI) and natural language processing (NLP) applications, specifically designed to assist sellers on e-commerce platforms such as Amazon, Walmart, and eBay. More particularly, the invention pertains to an AI chatbot application that streamlines the appeals process for sellers facing account suspensions on these platforms, by providing guidance, generating context-specific appeal letters, and offering tailored recommendations for addressing the underlying issues leading to the suspension.

### BACKGROUND OF THE INVENTION

Online marketplaces such as Amazon, Walmart, and eBay have revolutionized the way people buy and sell products worldwide. These platforms offer a vast array of opportunities for businesses and individual sellers to reach a wider audience and grow their revenues. However, due to the competitive nature of these marketplaces and the strict policies enforced by the platforms, sellers may sometimes face account suspensions. These suspensions can negatively impact their sales, reputation, and overall business operations.

Account suspensions may occur for various reasons, including policy violations, poor performance metrics, listing prohibited items, and other issues. When a seller's account gets suspended, they must go through an appeals process to have their account reinstated. This process typically involves understanding the cause of the suspension, addressing the underlying issues, and submitting a well-structured and persuasive appeal letter to the marketplace support team.

Crafting an effective appeal letter can be a challenging task, particularly for sellers who are unfamiliar with the nuances of the platform policies and guidelines. Moreover, the process of writing an appeal can be time-consuming, and sellers may not have the necessary resources or expertise to navigate the appeals process effectively. As a result, they may face delays in reinstating their accounts, leading to further losses in sales and customer trust.

In light of these challenges, there is a need for a solution that streamlines the appeals process and assists sellers in crafting well-structured, persuasive, and tailored appeals for account suspensions on Amazon, Walmart, and eBay. Such a solution should be capable of understanding the complexities of each suspension situation, guiding sellers through the process, and generating context-specific appeal letters to maximize the likelihood of successful account reinstatement. Additionally, the solution should be able to adapt to changes in platform policies and guidelines, ensuring that its guidance remains up-to-date and relevant.

### DISCLOSURE OF INVENTION

The primary purpose of the present invention is to provide an AI chatbot application that simplifies and expedites the appeals process for sellers experiencing account suspensions on e-commerce platforms such as Amazon, Walmart, and eBay. The invention aims to achieve this purpose by offering the following features and functionalities:

Engaging in natural language conversations with the seller, which allows the AI chatbot to understand the complexities of their suspension situation and gather relevant information.

Analyzing suspension reasons, platform policies, and guidelines to determine tailored recommendations for addressing the underlying issues and preventing future suspensions.

Generating context-specific, well-structured, and persuasive appeal letters that present a compelling case to the respective marketplace support teams, thereby maximizing the likelihood of successful account reinstatement.

Guiding the seller through the appeals process by providing step-by-step instructions, support, and real-time assistance, ensuring that they navigate the process effectively and confidently.

Continuously updating the AI chatbot's knowledge of platform policies, guidelines, and appeal writing strategies to adapt to any changes and maintain its relevance in providing up-to-date guidance.

By fulfilling these objectives, the invention aims to streamline the appeals process for sellers, allowing them to focus on their core business activities and minimize the negative impact of account suspensions on their sales, reputation, and overall operations.

### INVENTION DESCRIPTION

The present invention is an AI chatbot application specifically designed to assist sellers on Amazon, Walmart, and eBay platforms who are facing account suspensions. This innovative solution helps sellers craft well-structured, persuasive, and tailored appeals to reinstate their accounts by addressing the underlying issues that led to their suspension.

The AI chatbot utilizes advanced natural language processing (NLP) and machine learning (ML) techniques to engage in seamless conversations with the seller, allowing them to understand the complexities of their suspension situation and guiding them through the appeals process. By analyzing the reasons for each seller's account suspension, the AI chatbot is able to provide personalized recommendations on how to address the root causes and prevent future suspensions.

One of the key features of the AI chatbot is its ability to generate context-specific appeal letters, which are tailored to the unique circumstances of each seller's suspension. This maximizes the likelihood of a successful reinstatement by presenting a compelling case to the respective marketplace support teams.

Furthermore, the AI chatbot is capable of continuous learning, enabling it to improve its appeal writing abilities and adapt to changes in platform policies and guidelines over time. This ensures that the chatbot stays up-to-date with the latest trends and requirements, providing sellers with the most relevant and accurate guidance.

The AI chatbot application offers a cost-effective and efficient solution for sellers seeking to regain their account privileges on Amazon, Walmart, and eBay marketplaces. By streamlining the appeals process and leveraging the power of AI, the chatbot empowers sellers to focus on their core business activities while minimizing the impact of account suspensions.

1. An AI chatbot application for crafting appeals for Amazon, Walmart, and eBay seller account suspensions, comprising:
a. a natural language processing module for interpreting and understanding user input, as well as generating human-like responses;
b. a machine learning module for analyzing seller account suspension reasons, identifying relevant platform policies and guidelines, and determining appropriate recommendations for addressing the underlying issues;
c. an appeal generation module for creating context-specific, well-structured, and persuasive appeal letters based on the analyzed suspension reasons and tailored recommendations;
d. a continuous learning module for updating the AI chatbot's knowledge of platform policies, guidelines, and appeal writing strategies, thereby improving its performance over time.

2. The AI chatbot application of claim 1, wherein the natural language processing module engages in seamless conversations with the seller, allowing them to understand the complexities of their suspension situation and guiding them through the appeals process.

3. The AI chatbot application of claim 1, wherein the machine learning module utilizes historical suspension data, seller input, and platform policies to provide personalized recommendations on how to address the root causes of the suspension and prevent future suspensions.

4. The AI chatbot application of claim 1, wherein the appeal generation module maximizes the likelihood of successful account reinstatement by presenting a compelling case to the respective marketplace support teams.

5. The AI chatbot application of claim 1, wherein the continuous learning module enables the chatbot to adapt to changes in platform policies and guidelines, ensuring its guidance remains up-to-date and relevant.

6. The AI chatbot application of claim 1, wherein the application streamlines the appeals process for sellers, allowing them to focus on their core business activities and minimize the impact of account suspensions.

7. A method for crafting appeals for Amazon, Walmart, and eBay seller account suspensions using an AI chatbot application, comprising the steps of:
a. engaging in natural language conversations with the seller to gather information about their suspension situation;
b. analyzing suspension reasons, platform policies, and guidelines to determine tailored recommendations for addressing the underlying issues;
c. generating context-specific, well-structured, and persuasive appeal letters based on the analyzed suspension reasons and tailored recommendations;
d. updating the AI chatbot's knowledge of platform policies, guidelines, and appeal writing strategies through continuous learning, improving its performance over time.

8. The method of claim 7, further comprising the step of guiding the seller through the appeals process by providing step-by-step instructions and support.

9. The method of claim 7, further comprising the step of utilizing historical suspension data, seller input, and platform policies to provide personalized recommendations for addressing the root causes of the suspension and preventing future suspensions.

10. The method of claim 7, further comprising the step of presenting a compelling case to the respective marketplace support teams to maximize the likelihood of successful account reinstatement.
